(19) United States
(12) Patent Application Publication
(10) Pub. No.: US 2020/0157288 A1
(43) Pub. Date: May 21, 2020

(54) FLUORINE-CONTAINING COPOLYMER COMPOSITION

(71) Applicant: AGC Inc., Chiyoda-ku (JP)

(72) Inventors: Shigeru AIDA, Tokyo (JP); Kaori ABE, Tokyo (JP); Shintaro FUKUNAGA, Tokyo (JP)

(73) Assignee: AGC Inc., Chiyoda-ku (JP)

(21) Appl. No.: 16/750,115

(22) Filed: Jan. 23, 2020

Related U.S. Application Data
(63) Continuation of application No. PCT/JP2018/029657, filed on Aug. 7, 2018.

(30) Foreign Application Priority Data
Aug. 9, 2017 (JP) 2017-154280
Feb. 27, 2018 (JP) 2018-033410

(51) Int. Cl. C08J 3/09; C08F 214/26; C09D 127/18

(52) U.S. Cl. CPC C08J 3/095; C08J 2327/18; C09D 127/18; C08F 214/265

(57) ABSTRACT

Provided is a fluorine-containing copolymer composition capable of forming a uniform coating.

The composition comprises a fluorine-containing copolymer having units derived from tetrafluoroethylene, units derived from ethylene, and 0.4 to 1.0 mol % of at least one functional group selected from the group consisting of a carbonyl group-containing group, an acid anhydride group, a carboxy group, a hydroxy group, an epoxy group, an amide group, an amino group, and an isocyanate group, and an aliphatic compound having 6 to 10 carbon atoms having one carbonyl group.

### TECHNICAL FIELD

The present invention relates to a composition containing a fluorine-containing copolymer useful for coating various materials, a method for manufacturing the same, and the like.

### BACKGROUND ART

Fluororesins are excellent in solvent resistance, low dielectric properties, low surface energy, non-adhesiveness, weather resistance, and the like and are thus used in various applications where it is not possible to use general-purpose plastics. Among fluororesins, since an ethylene-tetrafluoroethylene copolymer (also referred to below as ETFE) is a fluororesin excellent in heat resistance, flame retardancy, chemical resistance, weather resistance, low friction properties, low dielectric properties, transparency, and the like, the ethylene-tetrafluoroethylene copolymer is used in a wide range of fields such as coating materials for heat-resistant electric wires, corrosion-resistant piping materials for chemical plants, vinyl house materials for agriculture, and mold release films.

However, unlike polyvinylidene fluoride, which dissolves in N-methylpyrrolidone or the like, ETFE, is generally insoluble in solvents and thin film forming or the like by coating is not possible, thus, the molding method thereof was limited to melt molding, such as extrusion molding, injection molding, and powder coating.

Regarding techniques to solubilize such low solubility ETFE, there is known a technique for obtaining a dissolved state using an aliphatic hydrocarbon compound having 6 to 10 carbon atoms having one carbonyl group as a solvent at a temperature which is the melting point of the ETFE or lower (for example, Patent Document 1). However, the coating property of the ETFE solution is not always sufficient and there are problems such as the ETFE coating becoming non-uniform in a case of being coated on metal or the like.

### CITATION LIST

### Patent Document

[Patent Document 1] International Publication No. 2011/002041

### DISCLOSURE OF INVENTION

### Problem to be Solved by the Invention

An object of the present invention is to provide a composition including a fluorine-containing copolymer which is useful for coating various types of materials and which has excellent coating properties.

### Means for Solving Problem

The present invention has the following aspects.

[1] A fluorine-containing copolymer composition comprising:

a fluorine-containing copolymer comprising units derived from tetrafluoroethylene, units derived from ethylene, and 0.4 to 1.0 mol % of at least one functional group selected from the group consisting of a carbonyl group-containing group, an acid anhydride group, a carboxy group, a hydroxy group, an epoxy group, an amide group, an amino group, and an isocyanate group; and

an aliphatic compound having 6 to 10 carbon atoms having one carbonyl group.

[2] The composition according to [1],

wherein the fluorine-containing copolymer is a copolymer obtainable by copolymerizing a monomer having a functional group (I), or a copolymer obtainable using a chain transfer agent or a polymerization initiator which provides the functional group (1).

[3] The composition according to [1],

wherein the fluorine-containing copolymer has units derived from tetrafluoroethylene, units derived from ethylene, and units derived from a monomer having a functional group, and a content of the units derived from a monomer having a functional group is 0.4 to 1.0 mol % with respect to a total of all units composing the fluorine-containing copolymer.

[4] The composition according to any one of [1] to[3],

wherein the functional group is an acid anhydride group, and a content of the units derived from a monomer having an acid anhydride group is 0.4 to 1.0 mol % with respect to a total of all units composing the fluorine-containing copolymer, as determined by a measurement method below.

Measurement method: A fluorine-containing copolymer is molded into a 200 him-thick press film, an infrared absorption spectrum is measured with an infrared spectrometer, an absorbance at a peak of 1870 cm⁻¹ is measured, and an acid anhydride group content of the fluorine-containing copolymer is measured according to a Beer-Lambert equation using a molar extinction coefficient of the peak (237 L/mol·cm).

[5] The composition according to any one of [1] to [4],

wherein the fluorine-containing copolymer further has units derived from a fluorine-containing monomer having one polymerizable carbon-carbon double bond.

[6] The composition according to any one of [1] to [5],

wherein a melting point of the fluorine-containing copolymer is 120 to 260° C.

[7] The composition according to any one of 111 to [6],

wherein the aliphatic compound is at least one type selected from the group consisting of ketones, esters, and carbonates.

[8] The composition according to any one of [1] to [7],

wherein the composition includes 0.05 to 30% by mass of the fluorine-containing copolymer and includes 70 to 99.95% by mass of the aliphatic compound.

[9] A method for manufacturing a composition containing a fluorine-containing copolymer, the method comprising:

mixing of a fluorine-containing copolymer having units derived from tetrafluoroethylene, units derived from ethylene, and 0.4 to 1.0 mol % of at least one functional group selected from the group consisting of a carbonyl group-containing group, an acid anhydride group, a carboxy group, a hydroxy group, an epoxy group, an amide group, an amino group, and an isocyanate group, with an aliphatic compound having 6 to 10 carbon atoms having one carbonyl group at a temperature of 0° C. or higher and of lower than a melting point of the fluorine-containing copolymer by 10° C. or more.

[10] A method for manufacturing a base material with a coating, the method comprising:

film-forming by coating the fluorine-containing copolymer composition according to any one of [1] to [8] on a base material.

[11] The method for manufacturing a base material with a coating according to [10],

wherein a thickness of the coating is 0.05 to 500 μm.

### Effects of the Invention

According to the present invention, it is possible to obtain a composition including a fluorine-containing copolymer having an excellent coating property. Coating the composition on a base material forms a uniform coating film on the base material and makes it possible to impart various types of effects such as chemical resistance, rust proofing, a water and oil repelling property, an anti-fouling property, and weather resistance to the base material.

### MODE FOR CARRYING OUT THE INVENTION

In the present specification, the “unit” in the fluorine-containing copolymer means an atomic group derived from one monomer molecule formed by polymerization of the monomer. The unit may be an atomic group directly formed by a polymerization reaction or an atomic group in which a part of the atomic group is converted into another structure by treating a polymer obtained by a polymerization reaction.

The fluorine-containing copolymer in the composition of the present invention has 0.4 to 1.0 mol % of at least one functional group (also referred to below as functional group (I)) selected from the group consisting of a carbonyl group-containing group, an acid anhydride group, a carboxy group, a hydroxy group, an epoxy group, an amide group, an amino group, and an isocyanate group, in the fluorine-containing copolymer and has units derived from tetrafluoroethylene (also referred to below as TFE units) and units derived from ethylene (also referred to below as E units).

The content of the functional group (I) in the fluorine-containing copolymer is obtained by molding the fluorine-containing copolymer into a 200 μm thick press film, measuring the infrared absorption spectrum using an infrared spectrometer (manufactured by Thermo Fisher Scientific Co., Ltd.), measuring the absorbance of the peak of the functional group (1), and measuring the content using the molar extinction coefficient of the peak according to the Beer-Lambert equation. For example, in a case where the functional group (I) is an itaconic anhydride residue, the peak is 1870 cm⁻¹ of the carbonyl group and the molar extinction coefficient is 237 L/mol·cm.

The molar ratio of TFE units/E units in the fluorine-containing copolymer is preferably 70/30 to 30/70, more preferably 65/35 to 40/60, and particularly preferably 60/40 to 50/50.

The content of the total of TFE units and E units to the total amount of all the units of the fluorine-containing copolymer is preferably 50 mol % or more, more preferably 70 mol % or more, even more preferably 80 mol % or more, and particularly preferably 90 mol % or more.

It is possible to manufacture the fluorine-containing copolymer by a method of copolymerizing a monomer having a functional group (I) when polymerizing the monomer or by a method such as polymerizing a monomer using a chain transfer agent or a polymerization initiator which provides the functional group (1).

As the monomer having a functional group (I), a monomer having a carbonyl group-containing group, a hydroxy group, an epoxy group, an amide group, an amino group, or an isocyanate group is preferable. As the carbonyl group-containing group, an acid anhydride group and a carboxy group are preferable. Specifically, examples thereof include monomers having a carboxy group such as maleic acid, itaconic acid, citraconic acid, and undecylenic acid, monomers having an acid anhydride group such as itaconic anhydride (also referred to below as IAH), citraconic anhydride (also referred to below as CAH), 5-norbornene-2,3-dicarboxylic acid anhydride (also referred to below as NAH), and maleic anhydride, hydroxyalkyl vinyl ether, epoxy alkyl vinyl ether, and the like.

As the chain transfer agent for providing the functional group (I), a chain transfer agent having a carboxy group, an ester bond, a hydroxyl group, or the like is preferable. Specifically, examples thereof include acetic acid, acetic anhydride, methyl acetate, ethylene glycol, propylene glycol, and the like.

As a polymerization initiator which provides the functional group (I), peroxide-based polymerization initiators such as peroxycarbonate, diacyl peroxide, and peroxyester are preferable. Specifically, examples thereof include di-n-propyl peroxydicarbonate, diisopropyl peroxycarbonate, tert-butyl peroxyisopropylcarbonate, bis (4-tert-butylcyclohexyl) peroxydicarbonate, di-2-ethylhexyl peroxydicarbonate, and the like.

As a method for manufacturing a fluorine-containing copolymer, it is preferable to manufacture a fluorine-containing copolymer having the functional group (I) by manufacturing a copolymer having units derived from a monomer having the functional group (I) (also referred to below as I units), by copolymerizing a monomer having the functional group (I).

The content of the functional group (I) in the fluorine-containing copolymer is 0.4 to 1.0 mol %, and more preferably 0.4 to 0.8 mol %. In particular, the content of the I units to the total of all the units forming the fluorine-containing copolymer is preferably 0.4 to 1.0 mol % and more preferably 0.4 to 0.8 mol %. When the functional group (I) and the I units are less than 0.4 mol %, the dispersibility of the fluorine-containing copolymer with respect to the solvent is insufficient and the appearance is non-uniform when the fluorine-containing copolymer is coated on various base materials, which is not preferable.

When the functional group (I) and the I units are 0.4 mol % or more, the fluorine-containing copolymer is easily mixed with an aliphatic compound having 6 to 10 carbon atoms having one carbonyl group and the composition of the present invention easily forms a uniform coating film when coated on a base material. In addition, when the content is 0.45 mol % or more, precipitate or the like is not easily generated even when the composition of the present invention is stored for a long period of time and the stability of the composition is improved.

When the functional group (I) and the I units are the upper limit or less with respect to the fluorine-containing copolymer, it is possible to increase the molecular weight of the fluorine-containing copolymer and prevent a decrease in the heat resistance, which is preferable.

The fluorine-containing copolymer may have units derived from other monomers apart from TFE units, E units, and I units. Preferable examples of other monomers include fluorine-containing monomers (excluding tetrafluoroethylene).

The fluorine-containing monomer is preferably a fluorine-containing compound having one polymerizable carbon-carbon double bond and examples thereof include fluoroolefin (vinyl fluoride, vinylidene fluoride, trifluoroethylene, hexafluoropropylene (HFP), hexafluoroisobutylene, and the like), CF₂═CFOR^{f1} (here, R^{f1} is a perfluoroalkyl group having 1 to 10 carbon atoms and which may include an oxygen atom between carbon atoms, also referred to below as PAVE), CF₂═CFOR^{f2}SO₂X¹ (here, R^{f2} is a perfluoroalkylene group having 1 to 10 carbon atoms and which may include an oxygen atom between carbon atoms, and X¹ is a halogen atom or a hydroxyl group), CF₂═CFOR^{f3}CO₂X² (here, R^{f3} is a perfluoroalkylene group having 1 to 10 carbon atoms and which may include an oxygen atom between carbon atoms, and X² is a hydrogen atom or an alkyl group having 1 to 3 carbon atoms), CF₂═CF(CF₂)ₚOCF═CF₂ (here, p is 1 or 2), CH₂═CX³(CF₂)_{q}X⁴ (here, X³ is a hydrogen atom or a fluorine atom, q is an integer of 2 to 10, and X⁴ is a hydrogen atom or a fluorine atom, also referred to below as FAE), a fluorine-containing monomer having a ring structure (perfluoro (2,2-dimethyl-1,3-dioxole), 2,2,4-trifluoro-5-trifluoromethoxy-1,3-dioxole, perfluoro (2-methylene-4-methyl-1,3-dioxolane), or the like), and the like.

From the viewpoint of excellent moldability, bending resistance of the polymer layer, and the like, the fluorine-containing monomer is preferably at least one type selected from the group consisting of HFP, PAVE, and FAE, and more preferably FAE and HFP.

The FAE is preferably CH₂═CH(CF₂)_{q1}X⁴ (here, q1 is 2 to 6, preferably 2 to 4), and CH₂═CH(CF₂)₂F, CH₂═CH(CF₂)₃F, CH₂═CH(CF₂)₄F, CH₂═CF(CF₂)₃H, CH₂═CF(CF₂)₄H are more preferable, and CH₂═CH(CF₂)₄F (also referred to below as PFBE) and CH₂═CH(CF₂)₂F (also referred to below as PFEE) are particularly preferable.

The content of the units derived from the fluorine-containing monomer with respect to the total of all the units composing the fluorine-containing copolymer is preferably 0.1 to 49 mol %, more preferably 0.5 to 29 mol %, even more preferably 1 to 19 mol %, and particularly preferably 1 to 9.5 mol %. When in the above ranges, the crack resistance is good and the melting point of the fluorine-containing copolymer does not decrease excessively, which is preferable.

The melting point of the fluorine-containing copolymer used in the present invention is preferably 120 to 260° C., more preferably 140 to 250° C., even more preferably 150 to 220° C., and most preferably 150 to 190° C.

The volume flow rate (referred to below as the Q value) of the fluorine-containing copolymer used in the present invention is preferably 1 to 500 mm³/second, more preferably 10 to 400 mm³/second, and most preferably 20 to 360 mm³/second. Within this range, the fluorine-containing copolymer is excellent in mechanical strength and heat resistance. The Q value is an index representing the melt fluidity of the fluorine-containing copolymer and is a measure of the molecular weight. When the Q value is large, the molecular weight is low, while a small Q value indicates a high molecular weight.

The Q value in the present specification is the extrusion rate of the fluorine-containing copolymer when extruding into an orifice having a diameter of 2.1 mm and a length of 8 mm under a load of 7 kg, using a flow tester manufactured by Shimadzu Corporation. The measurement temperature is preferably 297° C. in a case where the melting point of the fluorine-containing copolymer is high, and 220° C. in a case where the melting point is low. When the Q value is excessively small, the solubility deteriorates, and, when excessively large, the mechanical strength of the fluorine-containing copolymer decreases and cracks and the like are easily generated in a case of forming a coating film.

It is possible to manufacture the fluorine-containing copolymer by a known method. In a case of manufacturing a fluorine-containing copolymer by polymerizing monomers, as the polymerization method, a polymerization method using a radical polymerization initiator is preferable.

Examples of polymerization methods include bulk polymerization methods, solution polymerization methods using organic solvents (fluorinated hydrocarbons, chlorinated hydrocarbons, fluorinated chlorohydrocarbons, alcohols, hydrocarbons, and the like), suspension polymerization methods using an aqueous medium and appropriate organic solvents as necessary, and emulsion polymerization methods using an aqueous medium and an emulsifier, and a solution polymerization method is preferable.

In the composition of the present invention, it is possible to use these fluorine-containing copolymers alone as one type or as two types or more in combination.

It is possible to appropriately change the content of the fluorine-containing copolymer in the composition of the present invention according to the film thickness of the desired molded product. From the viewpoint of film formability, the content of the fluorine-containing copolymer is more preferably 0.05 to 30% by mass in the total amount of the composition, and most preferably 0.1 to 20% by mass. When the content is in this range, it is possible to form a uniform coating film having excellent handling properties such as viscosity, drying speed, and film uniformity.

The composition of the present invention contains an aliphatic compound having 6 to 10 carbon atoms having one carbonyl group together with the fluorine-containing copolymer.

Specific examples of the aliphatic compound having 6 to 10 carbon atoms having one carbonyl group include those examples described in [0040] to [0044] of Patent Document 1. In particular, 2-hexanone, methyl isobutyl ketone, 3,3-dimethyl-2-butanone, 2-heptanone, 3-heptanone, 4-heptanone, diisopropyl ketone, 5-methyl-2-hexanone, 2-octanone, 3-octanone, 5-methyl-3-heptanone, 2-nonanone, 5-nonanone, diisobutyl ketone, 2-decanone, 3-decanone, cyclohexanone, 3,3,5-trimethylcyclohexanone, isophorone, butyl acetate, isopentyl acetate, 2-ethylhexyl acetate, 1-methoxy-2-acetoxypropane, 3-methoxy-3-methylbutyl acetate, 2-methylcyclohexanone, 3-methylcyclohexanone, 4-ethylcyclohexanone, 2,6-dimethylcyclohexanone, 4-tert-butylcyclohexanone, (−)-fenchone, isopentyl formate, isobutyl acetate, pentyl acetate, hexyl acetate, cyclohexyl acetate, octyl acetate, ethyl butyrate, butyl butyrate, pentyl butyrate, methyl cyclohexanecarboxylate, 2,2,2-trifluoroethyl cyclohexanecarboxylate, ethyl perfluoroheptanoate, 2-ethoxyethyl acetate, 2-butoxyethyl acetate, 1-ethoxy-2-acetoxypropane, 3-methoxybutyl acetate, bis (2,2,3,3-tetrafluoropropyl) carbonate, and the like are preferable. Among these, diisopropyl ketone or butyl acetate is particularly preferable.

The content of the aliphatic compound in the composition of the present invention is preferably 70 to 99.95% by mass in the total amount of the composition, and more preferably 80 to 99.9% by mass. When the content is in this range, the handleability and the like are excellent at the time of coating in the coating production and it is possible to form an even and uniform coating film obtained from the composition. Two types or more of the aliphatic compounds may be used.

It is possible to manufacture the composition of the present invention by mixing the fluorine-containing copolymer and the aliphatic compound. In the composition, the fluorine-containing copolymer may be dissolved or dispersed in the aliphatic compound. The mixing may be performed at ordinary temperature or with heating.

The method for manufacturing the composition of the present invention is preferably a manufacturing method having a step of mixing the fluorine-containing copolymer with the aliphatic compound at a temperature which is the melting point of the fluorine-containing copolymer or lower. The mixing temperature is more preferably a temperature lower than a melting point of the fluorine-containing copolymer to be used by 10° C. or more.

Since the melting point of the fluorine-containing copolymer in the present invention is approximately 275° C. at the highest, the mixing temperature is more preferably 260° C. or lower, particularly preferably 200° C. or lower, and preferably 0° C. or higher, and more preferably 20° C. or higher. When the mixing temperature is less than 0° C., a sufficiently stable mixed state may not be obtained, and when the mixing temperature exceeds 260° C., it is not possible to easily perform the mixing when performing the actual operation. When the temperature is in this range, it is possible to facilitate the mixing operation.

The mixing temperature is particularly preferably a temperature 30° C. to 10° C. below the melting point of the fluorine-containing copolymer. In this range, the stability of the composition of the present invention is further improved and a precipitate is not likely to be generated even after long-term storage. For example, with a fluorine-containing copolymer having a melting point of 175° C., the temperature of the mixing step is particularly preferably 145 to 165° C.

It is usually preferable to carry out the mixing step under ordinary pressure conditions. In a case such as where the boiling point of the aliphatic compound to be used is lower than the temperature of the mixing step, example methods include mixing in a pressure container at least naturally occurring pressure or lower, preferably 3 MPa or lower, more preferably 2 MPa or lower, even more preferably 1 MPa or lower, most preferably ordinary pressure or lower, but it is usually possible to carry out the mixing under conditions of approximately 0.01 to 1 MPa.

In addition, in a case of diluting with nitrogen or the like in the pressure container in order to remove the gas phase from the combustion range of the aliphatic compound to be used, regarding the pressure in the pressure container, it is preferable to carry out the mixing at a pressure which is the vapor pressure of the aliphatic compound or more.

The mixing time depends on the content, shape, and the like of the fluorine-containing copolymer in the composition of the present invention. The form of the fluorine-containing copolymer is preferably powder form from the viewpoint of work efficiency for shortening the mixing time, but it is also possible to use pellets or other forms for ease of availability or the like.

The mixing means in the mixing step may be a known method. For example, it is sufficient if the necessary amount of each component to be blended in the composition is weighed, and these components are uniformly mixed at a temperature which is the melting point or lower of the fluorine-containing copolymer to be used, preferably at a temperature of 0 to 260° C. such that the fluorine-containing copolymer is mixed with the aliphatic compound. Specifically, it is preferable to carry out the mixing using a stirring mixer such as a homomixer, a Henschel mixer, a Banbury mixer, a pressure kneader, or a uniaxial or biaxial extruder. In a case of fluxing under pressure, an autoclave with a stirrer or the like is used, and, for the shape of the stirring blade, it is possible to use a marine propeller blade, a paddle blade, an anchor blade, a turbine blade, or the like.

It is possible for the composition of the present invention to contain other components apart from the fluorine-containing copolymer and the aliphatic compound, as necessary. Examples of the other components include various additives such as a curing agent, a curing accelerator, an adhesion improver, a surface adjusting agent, an antioxidant, a light stabilizer, an ultraviolet absorber, a cross-linking agent, a lubricant, a plasticizer, a thickener, a delustering agent, a dispersion stabilizer, a filling agent (filler), a reinforcing agent, a leveling agent, a pigment, a dye, a flame retardant, an antistatic agent, and other resins. In addition, as the content of these other components, possible examples include a content of 30% by mass or less with respect to the total amount of the composition for coating.

As the other component, a liquid component may be included in addition to the aliphatic compound. The liquid component including the aliphatic compound in the composition of the present invention is also referred to as a liquid medium. The liquid medium included in the composition of the present invention preferably includes 80% by mass or more of the aliphatic compound in the total amount of the liquid medium, and more preferably includes 90% by mass or more.

A pigment component may be contained in the composition of the present invention for the purpose of rust proofing, coloring, reinforcing, and the like. The pigment component is preferably one type or more of pigments selected from the group consisting of rust-proof pigments, coloring pigments, and extender pigments.

The rust-proof pigment is a pigment for preventing corrosion and deterioration of a metal plate. Lead-free rust-proof pigments with low environmental impact are preferable.

Examples of lead-free rust-proof pigments include zinc cyanamide, zinc oxide, zinc phosphate, calcium magnesium phosphate, zinc molybdate, barium borate, zinc calcium cyanamide, and the like.

The coloring pigment is a pigment for coloring the coating film. Examples of the coloring pigment include titanium oxide, carbon black, iron oxide, and the like. In addition, composite oxide pigments are also preferable and examples of commercially available products include composite oxide pigments of the “Daipyroxide” series (manufactured by Dainichiseika Color & Chemicals Mfg Co., Ltd.). Among these, “Daipyroxide Green #9430”, “Daipyroxide Black #9550”, and “Daipyroxide TM Red #8270” are preferable.

The extender pigment is a pigment for improving the hardness of the coating film and increasing the thickness of the coating film. Examples of extender pigments include talc, barium sulfate, mica, calcium carbonate, and the like.

Since pre-coated metal plates used for applications for building exterior materials are used for a long time outdoors under strong ultraviolet rays, it is necessary to take measures against deterioration of the metal plates due to the ultraviolet rays. Also, it is preferable to impart an ultraviolet absorbing function to the resin layer containing the fluorine-containing copolymer formed on the surface of the metal plate by adding an ultraviolet absorber to the composition of the present invention.

As the ultraviolet absorber, it is possible to use either organic types or inorganic types. Examples of the organic types include salicylic acid ester type, benzotriazole type, benzophenone type, cyanoacrylate type, and the like and inorganic types are preferably a filler type such as titanium oxide, zinc oxide, and cerium oxide.

In a case of using titanium oxide as the ultraviolet absorber, it is preferable to use titanium oxide composite particles.

The ultraviolet absorbers may be used alone as one type or in a combination of two types or more. The content of the ultraviolet absorber is preferably 0.1 to 15% by mass with respect to the mass of the fluorine-containing copolymer in the composition. In a case where the amount of the ultraviolet absorber is excessively small, the effect of improving the light resistance is not sufficiently obtained, and if the amount is excessively large, the effect is saturated.

Examples of the light stabilizer include hindered amines and the like, preferably, Adekastab LA62, Adekastab LA67 (the above are trade names of Adeka Argus Chemical Co., Ltd.), Tinuvin 292, Tinuvin 144, Tinuvin 123, Tinuvin 440 (the above are trade names of Ciba Specialty Chemicals), and the like.

The light stabilizer may be used as one type or in a combination of two types or more and may be used in combination with an ultraviolet absorber.

Examples of thickeners include polyurethane associative thickeners and the like.

As a delustering agent, it is possible to use a conventional inorganic or organic delustering agent such as ultrafine synthetic silica.

It is also possible to blend other resins with the composition of the present invention. Examples of other resins include non-fluorinated resins such as (meth)acrylic resin, polyester resin, acrylic polyol resin, polyester polyol resin, urethane resin, acrylic silicone resin, silicone resin, alkyd resin, epoxy resin, oxetane resin, amino resin, polyvinyl chloride, polystyrene, polycarbonate, and polyarylate. The other resin may be a resin having a cross-linkable functional group and which is cross-linked and cured by a curing agent.

In a case where another resin is blended in the composition of the present invention, the content of the other resin is preferably 1 to 200 parts by mass with respect to 100 parts by mass of the fluorine-containing copolymer.

It is possible to use the composition of the present invention as a liquid repelling additive due to the water-repelling property of the fluorine-containing copolymer. In addition, it is also possible to use the composition of the present invention as an oil lubricant or a solid lubricant. In addition, it is also possible to use the composition of the present invention as an adhesive due to adhesiveness of the fluorine-containing copolymer. It is also possible to use the adhesive as an adhesive layer between a metal and a resin, as well as an adhesive between resins, particularly between fluororesins.

It is possible to obtain a film by forming the composition of the present invention into a film. As the film forming method, various methods for coating on a carrier surface described below are preferable. It is possible to use the film as a glass scattering prevention film, a rubber plug wrapping, and the like. In addition, it is also possible to obtain an extremely thin cast film. In addition, it is also possible to use the film as a gas permeable film.

Coating the composition of the present invention on a base material such as metal, resin, glass, sapphire, ceramics, concrete, stone, paper, and wood makes it possible to impart chemical resistance, rust proofing, a water and oil repelling property, anti-fouling properties, lubricity, electrical insulation, weather resistance, sulfidation prevention, and the like thereto. Furthermore, if a functional group having a cross-linking property is introduced into the fluorine-containing copolymer and a cured resin layer is formed as a coating, the heat resistance, wear resistance, and the like are improved by the cross-linked structure.

Examples of the metal include metal plates such as carbon steel plates, stainless-steel plates, galvanium steel plates, aluminum plates, zinc plates, nickel plates, chromium plates, tin plates, and copper plates. In addition, examples of base materials to be coated in the present invention also include materials obtained by metal plating the surfaces of various metals, glass, ceramics, plastics, and the like. Examples of the metal plating include zinc plating, zinc-5% aluminum alloy plating, zinc-55% aluminum alloy plating, aluminum plating, nickel plating, chromium plating, gold plating, silver plating, copper plating, tin plating, nickel-chromium plating, and nickel-tin plating, manufactured by a melting method, or an electrolytic method, or the like. In addition, it is also possible to use a noble metal as a base material.

The resin is preferably a thermoplastic resin or a thermosetting resin. Specifically, polyethylene (high density polyethylene, medium density polyethylene, low density polyethylene, ultra-low density polyethylene, and the like), polypropylene, polybutene, polybutadiene, vinyl chloride resin, chlorinated vinyl chloride resin, ABS resin, polystyrene, methacrylic resin, norbornene resin, polyvinylidene chloride, polyesters such as polybutylene terephthalate and polyethylene naphthalate, polycarbonate, polyamide, polyimide, thermoplastic polyimide, polyamino bismaleimide, polysulfone, polyphenylene sulfide, polyether ether ketone, polyether imide, polyether ketone, polyethersulfone, polythioethersulfone, polyethernitrile, polyphenylene ether, thermosetting epoxy resin, urethane resin, urea resin, phenol resin, melamine resin, guanamine resin, furan resin, diallyl phthalate resin, aromatic polyamides, aromatic polyether amides, polyaryletherketone, polyamideimide, liquid crystal polyester, polycarbonate, and fluororesin are preferable.

In addition, materials including carbon black, various elastomer components, glass fibers, carbon fibers, and the like, in which the resin is a matrix, may be used as a base material.

The base material may be subjected to an electrical surface treatment such as a corona discharge treatment and a plasma discharge treatment, a metal sodium treatment, a mechanical surface roughening treatment, an excimer laser treatment, or the like.

The base material may have a film formed from a SiO₂ film or a silane coupling agent.

The method for coating the base material surface of the composition of the present invention is not particularly limited as long as it is possible to obtain a uniform coating. Specific examples of preferable coating methods include spin coater coating, bar coater coating, roll coater coating, and curtain flow coating. In addition, examples of other wet coating methods include a wipe coating method, a spray coating method, a squeegee coating method, a dip coating method, a die coating method, an ink jet method, a flow coating method, a casting method, the Langmuir-Blodgett method, a gravure coating method, a knife coating method, a blade coating method, an extrusion coating method, a rod coating method, an air doctor coating method, a kiss coating method, a fountain coating method, a screen coating method, a spray coating method, or the like.

Since the composition of the present invention is excellent in the dispersibility of the fluorine-containing copolymer, it is possible to form a fluorine-containing copolymer coating having a uniform appearance by coating the composition by a coating method described above and then drying the solvent and performing a heat treatment.

After coating the composition, the drying or heating may be performed as necessary to form a coating on the base material. A base material on which a coating is formed is also referred to as a base material with a coating. In the case of heating, the coating film formed on the base material is heated by a heating means, such as hot air heating, infrared heating, or induction heating, to bake the resin including the fluorine-containing copolymer and the resin is cross-linked as necessary to obtain a cured resin layer (coating). The heat treatment is preferably performed in a range of the melting point of the fluorine-containing copolymer contained in the composition or higher and the melting point +150° C. or lower. The heat treatment is more preferably performed at a temperature of approximately the melting point of the fluorine-containing copolymer +100° C.

The film thickness of the coating formed of the resin layer containing the fluorine-containing copolymer formed by coating the composition is preferably 0.05 to 500 μm, more preferably 0.5 to 100 win, and most preferably 1 to 20 μm. If the film thickness is less than 0.05 it is not possible to obtain sufficient performances such as weather resistance, chemical resistance, and rust proofing, on the other hand, if the film thickness exceeds 500 μm, not only is the workability in each step of coating decreased and the appearance of the coating and the hardness of the coating decreased, but the bending workability, scratch resistance, and the like are also inferior and the cost also increases, which is not preferable.

It is also possible to use the composition of the present invention for coating various members. For example, use is also possible for containers, pipes, valves and the like which handle water, warm water, acids, alkalis, organic solvents, powders, and the like. Specifically, examples thereof include metal containers, pits, bats, spoons, scoops, spatulas, pipes, hoses, tubes, bellows tubes, flanges, elbows, T-joints, cruciform joints, ball valves, needle valves, bellows valves, globe valves, butterfly valves, check valves, metal filters, and the like.

In addition, it is possible to suitably use the composition of the present invention as an inner surface coating agent for various articles. Examples of articles include glass containers such as glass vials, drug solution syringes, drip tubes, cosmetic containers, water bottles, ketchup/mayonnaise containers, and recycling containers.

In addition, in a case where the inner surface of the metal member is coated, problems such as rust do not occur since the metal member is protected from the fluid inside and metal components do not enter the fluid, which is preferable. In particular, in water quality management, the composition of the present invention is preferably used as an inner surface coating of a faucet fitting since a target value may be determined in which a nickel elution amount is preferably 0.02 mg/L or less.

In addition, it is also possible to use the composition of the present invention for coating kitchen and cooker-related items such as a faucet fitting, an IH cooking heater, a microwave oven part, an oven grill part, and a rice cooker inner container; various pipes such as exhaust gas pipes, automobile under-floor metal pipes, ducts, pipes for natural gas and oil, pipes or tanks for an N-methylpyrrolidone solution, and Tygon tubes; various marine equipment such as fishing lines, fishing nets, and submersible pumps; various types of blades such as pruning shears, medical knives, industrial blades, and shaving blades, to be imparted with an anti-fouling property, rust proofing, and non-adhesive properties; outdoor items such as asphalt, reinforcing bars, solar power mirrors, tombstones, screen doors, and curing panels; components used around water, such as shower curtains, toilets, bathtubs, Washlet (registered trademark) tips, and mops; cloth such as clothes and non-woven cloth; glass fiber, interior materials (including metal products), medical supplies, metal instruments, food packaging, metal eyeglass frames, copy transfer rolls, 3D printer molded articles, precious metal panels, metal screens, glass white boards, heat exchangers, and electric wires. In addition, it is also possible to use the composition as a patterning material by UV curing.

In addition, it is also possible to use the composition of the present invention as a moisture-proof coating for an electronic substrate, an ion migration-preventive coating for a multilayer ceramic capacitor, a liquid-repellent coating for the mouth of a cosmetic refill container or an ink jet head, a mold or rubber mold release coating, a gum adhesion prevention coating for bricks and tiles, an anti-scale coating for a minor, a water-repelling coating for carbon fiber reinforced plastic, an anti-discoloration coating for jewelry, an anti-fading coating for articles used outside, or a gear sliding improvement coating.

In addition, it is also possible to use the composition of the present invention as a binder and a separator coating for lithium ion secondary batteries, a separator coating for capacitors, or an all-solid lithium ion secondary battery binder.

Although partially overlapping with the applications above, more specific use examples include car navigation devices and car audio players for automobiles or the like, housing for various types of portable handheld devices such as tablet computers, notebook PCs, watch-type/glasses-type wearable terminals, mobile (communication) information terminals such as mobile phones and smartphones, digital cameras, digital video cameras, PDAs, portable audio players, game machines, various operation panels, digital media players, and electronic book readers, liquid crystal displays used in electronic adverts or the like, cathode ray tube displays (CRT: for example, TVs, and personal computer monitors), organic EL displays, plasma displays, inorganic thin film EL dot matrix displays, rear projection-type displays, vacuum fluorescent displays (VFD), displays such as field emission displays (FED: Field Emission Display) or front protective plates, anti-reflection plates, polarizing plates, or anti-glare plates thereof, item where a surface is subjected to an anti-reflection coating process, various devices with display input devices which are operated on a screen by human fingers or palms such as touch panel sheets and touch panel displays of devices such as mobile phones and mobile information terminals, copiers, solar panels, protective films, disc surfaces of optical discs such as Blu-ray (registered trademark) discs, DVD discs, CD-R, and MO and magnetic discs, optical fibers, watch display surfaces, and optical articles such as prisms, lens sheets, pellicle films, polarizing plates, optical filters, lenticular lenses, Fresnel lenses, antireflection films, optical fibers, light couplers, spectacle lenses, anti-reflection coated ophthalmic lenses, binocular lenses, camera lenses, lens filters, sunglasses, and medical instruments such as stomach cameras. In particular, examples thereof include various devices having display input devices which are operated on a screen by human fingers or palms such as touch panel displays, digital photo frames, game machines, automatic cash withdrawal and deposit devices, cash dispensers, vending machines, digital signage (electronic signboards), security system terminals, POS terminals, various controllers such as remote controllers, and surface protective coatings for display input devices such as panel switches for in-vehicle devices or the like.

In addition, use is also possible as a protective film for the exteriors of bicycles and automobiles, glossy surfaces of pianos and furniture, architectural stone surfaces such as marble and artificial marble, decorative building materials used around water for toilets, baths, washrooms, kitchens, and the like, home appliances with glass decoration (for example, refrigerators), protective glass for art exhibits, show windows, showcases, photo frame covers, wristwatches, glass for automobile windows, window glass for trains, aircraft, and the like, transparent glass or plastic (acrylic, polycarbonate, and the like) members such as automobile headlights and tail lamps, various mirror members, retroreflective sheeting, building windows, vehicle headlamps and taillights, display cases, road pavement markers (for example, bumps), pavement marking tapes, overhead projectors, stereo cabinet doors, stereo covers, watch covers, ceramic products, fabric products, leather products, medical products, medical equipment, automobiles, aircraft, helicopters, aerospace aircraft; O-rings, shaft seals, gaskets, tubes, lining, sheets, containers, lids, hoses, or components thereof used in ship exteriors and fuel systems, film and bonded seals, bearings, crankshafts, slide bearings, pistons, gaskets, gears, door panels, instrument panels, door locks, timing belts, sunroof body seals, glass runs, weather strips, rotary/slide bearings, pivot pins, cams, guides, ways, drive screws, gears, splines, chains, and the like. Use is also possible as a water-repelling coating for batteries such as air (zinc) batteries, a water-repelling coating for electrolytic cell members, a water-repelling coating for solar cells, a waterproof/water-repelling coating for printed wiring boards, a waterproof/water-repelling coating for electronic equipment housings and electronic parts, an anti-fouling coating for charging rolls and fixing rolls, an anti-fouling coating for substrate transport devices, an insulation improvement coating for high-frequency heating elements, an insulation improvement coating for power transmission lines, a waterproof/water-repelling coating for various filters, a waterproof coating for radio wave absorbing materials and sound absorbing materials, baths, kitchen equipment, and anti-fouling coatings for toiletries.

Use is also possible as various mold release molds for extrusion molding, injection molding, calendar molding, blow molding, FRP molding, laminate molding, casting, powder molding, solution casting methods, vacuum/pressure molding, extrusion composite molding, stretch molding, foam molding, adhesives/paints, various types of secondary processing, compression molding, hollow molding, nanoimprinting, and the like; a release agent for urethane foam, a release agent for concrete, a release agent for rubber/plastic molding, water-repelling/waterproof/sliding/rust-proof coatings for a heat exchanger, surface low friction coatings inside vibrating screens and cylinders, surface protection coatings for machine parts, vacuum equipment parts, bearing parts, automobile parts, tools, and the like.

Use is also possible for containers, pipes, valves, and the like which handle water, warm water, acids, alkalis, organic solvents, powders, and the like. Specifically, use is possible in rust-proof, anti-moisture, and anti-fouling coatings for metal containers, pits, bats, spoons, scoops, spatulas, pipes, hoses, tubes, bellows-shaped tubes, flanges, elbows, T-joints, cruciform joints, ball valves, needle valves, bellows valves, globe valves, butterfly valves, check valves, metal filters, drums, and the like.

Use is also possible for a UV-cut coating with an inorganic particle composite, a coating for solar heat collecting reflector, front and back sheets for a solar cell, wind power generator blade surface coating paint, a toner coating, optical fiber cladding and lens materials, mirrors, a glass window coating, syringes, pipettes, thermometers, beakers, petri dishes, graduated cylinders, impregnation into fibers and fabrics, anti-fouling coating agents for sealants, IC sealing material, rust-proof paint, a resin adhesion prevention coating, an ink adhesion prevention coating, interlayer insulating films, semiconductor manufacturing protective films, and the like.

Use is possible for anti-fouling coatings, sound insulation plates, and concrete members for station home doors, automatic doors, outdoor security cameras, shutters, vending machines, and the like; anti-fouling coatings for utility poles, roads, walls, and the like, anti-fouling/anti-soot adhesion coatings for exhaust gases, anti-fouling coatings for glass for buildings, automobiles, aircraft, and trains, rust-proof and anti-fouling coatings for roofing materials and steel sheets for building exteriors, anti-fouling coatings for building interior materials such as wallpaper, flooring, and tiles, and weather resistant coatings for electromagnetic shielding sheets, anti-fouling coatings for indoor and outdoor advertising, anti-corrosion coatings for transfer robot arms, anti-fouling coatings for camera housing, low friction/water-repelling coatings for ink jet nozzles, ceramic chemical-resistant coatings used as a base for photolithography steps, release coatings for nanoimprint molds, tire deterioration prevention coatings, low friction coatings for metal chains, belts, rotors, pistons, transport guides, and transport film rolls, chemical-resistant coatings for nickel metal hydride battery electrodes, and anti-burn coatings for kitchenware; anti-fouling coatings for utensils used with water such as pans, frying pans, rice cookers, confectionery molds, rice cake makers, crepe makers, waffle makers, takoyaki cookers, and hot plates; anti-fouling coats for insulators in washing machines, dryers, dishwashers, and the like, rust-proof and non-adhesive coatings for plating tanks, plating jigs, washing containers, washing baskets, for stirrers, shafts, stirring blades, electric immersion heaters, and the like, metal ion elution prevention coatings for wet cleaning equipment for semiconductor manufacturing, anti-corrosion coatings for CMP polishing devices, insulation coatings for CCL for printed circuit boards, moisture-proof coatings for gas separation films and electronic circuit boards, electrode protective coatings for electronic circuit boards, lubricants; fluorine-containing solid lubricants, fluorine-containing oil lubricants, additives; water-repelling property imparting additives, oil repelling property imparting additives, lubricity imparting additives, cosmetic container inner surface coatings, inner surface coatings for chemical solution bags, drip bags and chemical solution syringes, inner surface coatings for ketchup and mayonnaise containers, fluororesin chemical resistant adhesives, chemical resistant adhesive agents for fluororesin and other base materials, patterning materials, moisture-proof coatings for flexible display substrates, water-repelling, chemical resistant, moisture-proof, mold release, and anti-fouling coatings for 3D printer molded articles, and the like.

### EXAMPLES

A description will be given of Examples of the present invention, but the present invention is not to be interpreted as being limited thereto.

### (Volume Flow Rate Q Value Mm³/Sec)

Using a flow tester (manufactured by Shimadzu Corporation), the extrusion rate of the fluorine-containing copolymer was measured when extruded into an orifice having a diameter of 2.1 mm and a length of 8 mm under a load of 7 kg at a temperature of 220° C.

### [Melting Point]

Using a differential scanning calorimeter (manufactured by SII, DSC-7020), approximately 5 mg of a sample was held at 300° C. for 10 minutes under a flow of dry air, then cooled to 100° C. at a rate of 10° C./min, and the temperature corresponding to the top of the crystal melting peak when the temperature was raised to 300° C. at a rate of 10° C./min was taken as the melting point.

### [ETFE Composition]

The ETFE composition was determined by melt NMR analysis and fluorine content analysis.

### [Content of Functional Group (Acid Anhydride Group)]

ETFE was formed into a 200 μm-thick press film and an infrared absorption spectrum was measured with an infrared spectrometer (manufactured by Thermo Fisher Scientific Co., Ltd.). The absorbance of the peak at 1870 cm⁻¹ attributed to the carbonyl group of the acid anhydride was measured, and, using the molar extinction coefficient (237 L/mol·cm) of the peak of itaconic anhydride, which was the monomer unit of the functional group, the functional group content of ETFE was determined from the Beer-Lambert equation.

### Synthesis Example 1

A stainless-steel polymerization tank having an internal volume of 1.3 L and provided with a stirrer and a jacket was vacuum suctioned, then charged with 822 g of CF₃CH₂OCF₂CF₂H, 3.2 g of CH₂═CH(CF₂)₄F, and 1.98 g of methanol, and further charged with 350 g of HFP, 118 g of TFE, and 2.9 g of E while stirring the inside of the polymerization tank, then, warm water was allowed to flow in the jacket to heat the inside of the polymerization tank to 66° C. The polymerization tank internal pressure at this time was 1.53 MPaG. After the internal temperature stabilized, 8.4 mL of a 5% by mass CF₃CH₂OCF₂CF₂H solution of tert-butylperoxypivalate was press-fitted thereto to initiate polymerization. During the polymerization, a mixed gas with a TFE/E=54/46 molar ratio was added thereto such that the internal pressure was constant at 1.53 MPaG. In addition, every time 5 g of TFE/E mixed gas added during polymerization was consumed, 4 mL of a CF₃CH₂OCF₂CF₂H solution of 3.52% by mass of CH₂═CH(CF₂)₄F and 1.28% by mass of itaconic anhydride was added thereto. After 283 minutes from the start of the reaction, when 70 g of a mixed gas of TFE/E (molar ratio)=54/46 was added thereto, the polymerization tank was cooled to complete the polymerization.

Next, the residual monomer gas was purged from the polymerization tank to atmospheric pressure, the slurry was transferred to a container with an internal volume of 2 L, water of the same volume as the slurry was added thereto, and the polymerization medium, residual monomer, and fluorine-containing copolymer were separated while heating. The obtained polymer was dried in an oven at 120° C. to obtain ETFE-1 in white powder form.

The volume flow rate of ETFE-1 at 220° C. was 35 mm³/sec, the composition (mol % ratio) was TFE/E/HFP/CH₂═CH(CF₂)₄F/itaconic anhydride=49.0/41.7/7.8/1.1/0.4, and the melting point was 178° C.

### Synthesis Example 2

In the same manner as in Synthesis Example 1 except that methanol was not charged therein, raw material was charged into the polymerization tank, then, warm water was allowed to flow in the jacket to heat the inside of the polymerization tank to 66° C. The polymerization tank internal pressure at this time was 1.53 MPaG. After the internal temperature stabilized, 16.8 mL of a 5% by mass CF₃CH₂OCF₂CF₂H solution of tert-butylperoxypivalate was press-fitted thereto to initiate polymerization. During the polymerization, a mixed gas with a TFE/E=54/46 molar ratio was added thereto such that the internal pressure was constant at 1.53 MPaG. In addition, every time 5 g of TFE/E mixed gas added during polymerization was consumed, 4 mL of a CF₃CH₂OCF₂CF₂H solution of 3.53% by mass of CH₂═CH(CF₂) 4F and 1.61% by mass of itaconic anhydride was added thereto. 222 minutes after the start of the reaction, when 70 g of a mixed gas of TFE/E (molar ratio)=54/46 was added thereto, the polymerization tank was cooled to complete the polymerization.

Next, the residual monomer gas was purged from the polymerization tank to atmospheric pressure, the slurry was transferred to a container with an internal volume of 2 L, water of the same volume as the slurry was added thereto, and the polymerization medium, residual monomer, and fluorine-containing copolymer were separated while heating. The obtained polymer was dried in an oven at 120° C. to obtain ETFE-2 in white powder form.

The volume flow rate of ETFE-2 at 220° C. was 193 mm³/sec, the composition (mol % ratio) was TFE/E/HFP/CH₂═CH(CF₂)₄F/itaconic anhydride=49.1/41.5/7.7/1.2/0.5, and the melting point was 174° C.

### Synthesis Example 3

ETFE-3 was obtained in the same manner as in Synthesis Example 1 except that the amount of itaconic anhydride added was changed. The volume flow rate of ETFE-3 at 220° C. was 355 mm³/sec, the composition (mol % ratio) was TFE/E/HFP/CH₂═CH(CF₂)₄F/itaconic anhydride=49.0/41.6/7.7/1.1/0.6, and the melting point was 176° C.

### Synthesis Example 4

In the same manner as in Synthesis Example 1 except that 1.65 g of methanol was charged therein, raw material was charged into the polymerization tank, then, warm water was allowed to flow in the jacket to heat the inside of the polymerization tank to 66° C. The polymerization tank internal pressure at this time was 1.56 MPaG. After the internal temperature stabilized, 5.4 mL, of a 5% by mass CF₃CH₂OCF₂CF₂H solution of tert-butylperoxypivalate was press-fitted thereto to initiate polymerization. During the polymerization, a mixed gas of TFE/E (molar ratio)=54/46 was added thereto such that the internal pressure was constant at 1.56 MPaG. In addition, every time 5 g of TFE/E mixed gas added during polymerization was consumed, 2 mL of a CF₃CH₂OCF₂CF₂H solution of 7.1% by mass of CH₂═CH(CF₂)₄F and 1.3% by mass of itaconic anhydride was added thereto. 347 minutes after the start of the reaction, when 70 g of a mixed gas of TFE/E (molar ratio)=54/46 was added thereto, the polymerization tank was cooled to complete the polymerization.

Then, the residual monomer gas was purged from the polymerization tank to atmospheric pressure, the slurry was transferred to a container with an internal volume of 2 L, water of the same volume as the slurry was added thereto, and the polymerization medium, residual monomer, and fluorine-containing copolymer were separated while heating. The obtained polymer was dried in an oven at 120° C. to obtain ETFE-4 in white powder form.

The volume flow rate of ETFE-4 at 220° C. was 14 mm³/sec, the composition (mol % ratio) was TFE/E/HFP/CH₂═CH(CF₂)₄F/itaconic anhydride=49.2/41.7/7.8/1.0/0.3, and the melting point was 195° C.

### Example 1-1

32 g of ETFE-1 as a fluorine-containing copolymer and 500 g of diisopropyl ketone were added to a 1 L glass pressure-resistant reaction container provided with a stirrer, heated to 150° C., and stirred for 1 hour to disperse the ETFE-1. Thereafter, the result was cooled to room temperature while stirring to obtain an ETFE composition 1-1.

The ETFE composition 1-1 was dip-coated on an aluminum plate treated with allodin. When the solvent was dried at room temperature and then heat treated at 250° C. for 30 minutes, it was possible to form a uniform and transparent ETFE-1 coating film.

### Example 1-2

An ETFE composition 1-2 was obtained in the same manner as in Example 1-1 except that 10 g of ETFE-1 was used. The aluminum plate treated with allodin was dip-coated with ETFE composition 1-2. When the solvent was dried at room temperature and then heat treated at 250° C. for 30 minutes, it was possible to form a uniform and transparent ETFE-1 coating film.

### Example 1-3

An ETFE Composition 1-3 was obtained in the same manner as Example 1-1 except that diisopropyl ketone was changed to butyl acetate. The aluminum plate treated with allodin was dip-coated with ETFE composition 1-3. When the solvent was dried at room temperature and then heat treated at 250° C. for 30 minutes, it was possible to form a uniform and transparent ETFE-1 coating film.

### Example 1-4

An ETFE composition 1-4 was obtained in the same manner as in Example 1-3, except that ETFE-1 was changed to 10 g. The aluminum plate treated with allodin was dip-coated with the ETFE composition 1-4. When the solvent was dried at room temperature and then heat treated at 250° C. for 30 minutes, it was possible to form a uniform and transparent ETFE-1 coating film.

### Example 2

An ETFE composition 2 was obtained in the same manner as in Example 1-1 except that the fluorine-containing copolymer was changed to ETFE-2. The ETFE composition 2 had excellent stability without precipitation or the like even after 72 hours at room temperature.

In the same manner as Example 1-1 except that the ETFE composition 1-1 was changed to the ETFE composition 2, when a coating film of ETFE-2 was formed on an aluminum plate treated with allodin, a uniform coating film having greater transparency than the coating film of Example 1-1 to Example 1-4 was obtained.

### Example 3

An ETFE composition 3 was obtained in the same manner as in Example 1-1 except that the fluorine-containing copolymer was changed to ETFE-3. The ETFE composition 3 had excellent stability without precipitation or the like even after 72 hours at room temperature.

In the same manner as Example 1-1 except that the ETFE composition 1-1 was changed to the ETFE composition 3, when a coating film of ETFE-3 was formed on the aluminum plate treated with allodin, a uniform coating film having greater transparency than the coating film of Example 1-1 to Example 1-4 was obtained.

### Example 4

232.5 g of ETFE composition 1-1 and 1.21 g of Daipyroxide Green #9430 as a green pigment were added and stirred to obtain an ETFE composition 4 colored by the green pigment.

The ETFE Composition 4 was dip-coated on a sandblasted stainless-steel plate. When the solvent was dried at room temperature and then heat treated at 250° C. for 30 minutes, it was possible to form a uniform green ETFE-1 coating film.

### Example 5

230.5 g of ETFE composition 1-1 and 0.73 g of Daipyroxide Black #9550 as a black pigment were added and stirred to obtain an ETFE composition 5 colored by a black pigment.

ETFE composition 5 was dip-coated on a sandblasted stainless-steel plate. When the solvent was dried at room temperature and then heat treated at 250° C. for 30 minutes, it was possible to form a uniform black ETFE-1 coating film.

### Comparative Example 1

An ETFE composition 6-1 was obtained in the same manner as in Example 1-1 except that the fluorine-containing copolymer was changed to ETFE-4.

In the same manner as in Example 1-1, when the ETFE composition 6-1 was applied to an aluminum plate treated with allodin and heat-treated, in the coating film of ETFE-4, unevenness was generated in the appearance with different transparency in parts and it was not possible to form a uniform coating film as in Example 1.

### Comparative Example 2

An ETFE composition 6-2 was obtained in the same manner as in Comparative Example 1 except that diisopropyl ketone was changed to butyl acetate.

In the same manner as in Example 1-1, when the ETFE composition 6-2 was applied to an aluminum plate treated with allodin and heat-treated, in the coating film of ETFE-4, unevenness was generated in the appearance with different transparency in parts and it was not possible to form a uniform coating film as in Example 1-1.

This application is a continuation application of International Application No. PCT/JP2018/029657, filed on Aug. 7, 2018, which claims the benefit of priority of the prior Japanese Patent Application No. 2017-154280 filed on Aug. 9, 2017 and Japanese Patent Application No. 2018-033410 filed on Feb. 27, 2018, the entire contents of the specification, claims, drawings, and abstract of which are referenced and incorporated herein as the disclosure of the specification of the present invention.

1. A fluorine-containing copolymer composition comprising:
a fluorine-containing copolymer comprising units derived from tetrafluoroethylene, units derived from ethylene, and 0.4 to 1.0 mol % of at least one functional group selected from the group consisting of a carbonyl group-containing group, an acid anhydride group, a carboxy group, a hydroxy group, an epoxy group, an amide group, an amino group, and an isocyanate group; and
an aliphatic compound having 6 to 10 carbon atoms having one carbonyl group.

2. The composition according to claim 1,
wherein the fluorine-containing copolymer is a copolymer obtainable by copolymerizing a monomer having a functional group (I), or a copolymer obtainable using a chain transfer agent or a polymerization initiator which provides the functional group (I).

3. The composition according to claim 1,
wherein the fluorine-containing copolymer has units derived from tetrafluoroethylene, units derived from ethylene, and units derived from a monomer having a functional group, and a content of the units derived from a monomer having a functional group is 0.4 to 1.0 mol % with respect to a total of all units composing the fluorine-containing copolymer.

4. The composition according to claim 1,
wherein the functional group is an acid anhydride group, and a content of the units derived from a monomer having an acid anhydride group is 0.4 to 1.0 mol % with respect to a total of all units composing the fluorine-containing copolymer, as determined by a measurement method below.
Measurement method: A fluorine-containing copolymer is molded into a 200 μm-thick press film, an infrared absorption spectrum is measured with an infrared spectrometer, an absorbance at a peak of 1870 cm⁻¹ is measured, and an acid anhydride group content of the fluorine-containing copolymer is measured according to a Beer-Lambert equation using a molar extinction coefficient of the peak (237 L/mol·cm).

5. The composition according to claim 1,
wherein the fluorine-containing copolymer further has units derived from a fluorine-containing monomer having one polymerizable carbon-carbon double bond.

6. The composition according to claim 1,
wherein a melting point of the fluorine-containing copolymer is 120 to 260° C.

7. The composition according to claim 1,
wherein the aliphatic compound is at least one type selected from the group consisting of ketones, esters, and carbonates.

8. The composition according to claim 1,
wherein the composition includes 0.05 to 30% by mass of the fluorine-containing copolymer and includes 70 to 99.95% by mass of the aliphatic compound.

9. A method for manufacturing a composition containing a fluorine-containing copolymer, the method comprising:
mixing of a fluorine-containing copolymer having units derived from tetrafluoroethylene, units derived from ethylene, and 0.4 to 1.0 mol % of at least one functional group selected from the group consisting of a carbonyl group-containing group, an acid anhydride group, a carboxy group, a hydroxy group, an epoxy group, an amide group, an amino group, and an isocyanate group, with an aliphatic compound having 6 to 10 carbon atoms having one carbonyl group at a temperature of 0° C. or higher and of lower than a melting point of the fluorine-containing copolymer by 10° C. or more.

10. A method for manufacturing a base material with a coating, the method comprising:
film-forming by coating the fluorine-containing copolymer composition according to claim 1 on a base material.

11. The method for manufacturing a base material with a coating according to claim 10,
wherein a thickness of the coating is 0.05 to 500 μm.
